(19) United States
(12) Patent Application Publication
(10) Pub. No.: US 2007/0270553 A1
(43) Pub. Date: Nov. 22, 2007

(54) MASKING OF WINDOW FLANGES WITH AN ADHESIVE TAPE COMPRISING A SELF-ADHESIVE COMPOSITION BASED ON CROSSLINKED VINYLAROMATIC BLOCK COPOLYMERS

(75) Inventors: Nicolai Bohm, Hamburg (DE); Thorsten Krawinkel, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, Hamburg (DE)

(21) Appl. No.: 11/750,585

(22) Filed: May 18, 2007

(30) Foreign Application Priority Data
May 19, 2006 (DE) 10 2006 023 936.9

(51) Int. Cl. C08L 53/00; C08F 297/00

(52) U.S. Cl. 525/314; 525/88

(57) ABSTRACT

Use of an adhesive tape for masking substrates, especially substrates coated with cathodic electrocoat (CED) material, more preferably window flanges, with a single-layer or multi-layer backing and applied to one side thereof a self-adhesive composition comprising metal chelate-crosslinkable vinylaromatic block copolymers, preferably styrene block copolymers, which are blended at least with one or more tackifier resins, the vinylaromatic block copolymers being at least partly acid-modified or acid anhydride-modified.

The invention relates to the use of an adhesive masking tape comprising a self-adhesive composition based on crosslinked vinylaromatic block copolymers for the purpose in particular of masking window flanges, particularly in automobile body shells coated with cathodic electrocoat (CED) material. The purpose of the adhesive masking tape is to protect the window flanges against overpainting during the subsequent painting and baking operations, such that, following the removal of the masking tape, a glass automobile window can be installed on the surfacer- and clearcoat-free window flange using a reactive PU window adhesive.

Automobile glass windows are conventionally mounted in the painted vehicle body using rubber seals. In recent years, this technique has increasingly been replaced by the installation of the windows using reactive adhesives (based, for example, on polyurethane). In this case the window is provided with an adhesive bead on the rim and is placed onto the body in such a way that the adhesive bead is pressed onto the window flange.

The installed windows, especially the windscreens, nowadays act as a reinforcing element of the body. In the extreme case, that of the vehicle turning over, they prevent buckling of the roof columns. Consequently, a sufficient bond strength is critical to the safety of a modern motor vehicle in an accident situation.

Modern automotive finishes are composed of various coats, which are applied to the primed bodywork metal in the following order (schematically):
electrophoretic coat, usually cathodic electrocoat (CED),
surfacer or functional coat,
colour topcoat,
clearcoat.

Electrophoretic coating (electrodeposition coating or electrocoating) is a technique in which coating takes place by the action of an electrical field (50 to 400 V). The article to be painted, which conducts electric current, is introduced, as the anode or cathode, into the paint bath, with the tank wall acting in practice as the second electrode.

The quantity of paint deposited is directly proportional to the amount of current supplied. Electrophoretic coating is used particularly for priming. There are no spray losses, and the coatings obtained are very uniform, even in difficult-to-reach areas. Where the substrates are not conducting, as in the case of plastics, glass, ceramic, etc., coating is carried out by way of the electrostatic charging of the paint particles (known as electro-static coating).

All electrocoat materials are water-soluble (suspensions of binders and pigments in demineralized water) with only low concentrations of organic solvents (approximately 3%). Consequently there is no need for either fire protection or special occupational hygiene measures when operating CED plants.

Within the automotive industry, cathodic electrodeposition coating is preferred. The CED bath consists to the extent of approximately 80% of water; 19% is binders and pigments, and only about 1% to 2% organic solvents. The pH is slightly acidic, at approximately 6 to 6.5. The deposition mechanism breaks down into a number of stages: the water-insoluble synthetic resin becomes dispersible in water only in conjunction with an organic acid. In the region of the negatively charged workpiece (cathode), the evolution of hydrogen produces an alkaline boundary layer (pH 11 to 13). As a result of the increased OH-concentration at the surface of the workpiece, the aqueously dissolved coating material undergoes coagulation, and deposits in the form of a fine paint coat on the component. In order to prevent sedimentation and to rule out the formation of dead spaces, the bath in the tank is agitated with an average flow rate of approximately 0.2 m/s; based on the tank contents, the bath is circulated 4 to 6 times per hour. With paint consumption of 2 to 3 kg/body and with a not insignificant level of water evaporation at bath temperatures around 30° C, the composition of the bath must be regulated continually. The organic acids liberated at the anode are separated off by a dialysis system, so that the bath pH is kept stable.

This is followed by a multi-stage rinsing zone, using ultrafiltrate from the paint recovery process, or demineralized water.

If the car window is adhered to the window flange after the painting operation has been concluded, and if the window flange as well has been painted, the following disadvantages arise. Since the window adhesive has to be matched to the clearcoat as its adhesion substrate, a high degree of complexity may result, given the multiplicity of clearcoat materials used by a manufacturer, since it is necessary to hold in stock a multiplicity of appropriate adhesives. More important, however, is the fact that the overall bond strength of the car window is dependent on the weakest point in the multi-coat paint system, and may therefore be much lower than the bond strength of the adhesive to the clearcoat.

It is advantageous, therefore, to apply the window to the bottommost paint coat, the CED coat. The number of CED products used by a manufacturer is typically lower than the number of clearcoat materials. Firstly, there are few defined adhesion substrates for the window adhesive, as a result, and, secondly, the system comprising metal/CED/window adhesive, with two boundary layers, harbours a lower risk of fracture than a complex overall coating system.

To mask the window flange following the application of the cathodic electrocoat it is possible to use a PVC plastisol, as described in EP 0 655 989 B1. This plastisol is applied in liquid form to the window flange, painted over, and gelled during the baking phase at temperatures of at least 163° C., to form a solid film. A disadvantage of this technique is that, for the purpose of demasking after baking has taken place, it is necessary for a “grip tag” to be exposed mechanically, in which case the electrocoat as well may easily be damaged, harbouring the risk of subsequent corrosion.

On the window flanges, the plastisol strip crosses—in some cases more than once—PVC seam sealants which fill welled seams. On gelling, instances of severe sticking between seam sealants and PVC plastisol window flange masking are frequently observed, and make trouble-free demasking more difficult. Likewise observed are instances of plastisol-related contamination of the adhesion substrate, so giving rise to an adhesion failure at the boundary between window adhesive and formerly plastisol-masked electrocoat.

As a result, the requisite bonding reliability of the window is not ensured.

Although this drawback can be countered through the use of a primer, such a step is labour-intensive, leads to unwanted solvent emissions, and may necessitate repair to the paint, as a result of accidental splashing or dripping on the clearcoat.

A more advantageous means of masking window flanges is the use of self-adhesive tapes. Their advantage over the plastisol is the much lower layer thickness of 100 to 200 μm, producing a correspondingly lower weight of waste per vehicle masked. Given the correct design of the backing of adhesive tape, it can be adhered not only by hand but also in an automated procedure, by robot.

As with the plastisol it is also the case here that the adhesive of the adhesive masking tape must not induce any contamination of the adhesion substrate such that adhesion failure is evident at the boundary between window adhesive and formerly masked electrocoat.

Known for this application is the use of self-adhesive compositions based on natural rubber, acrylic ester copolymers and styrene block copolymers. With both of the former, adhesion defects are observed again and again.

It has since been recognized that the adhesion defects come about as a result of a complex interaction of
1. cathodic electrocoat and its baking conditions,
2. window adhesive and its reactivity,
3. adhesive masking tape,
4. baking conditions of seam sealant, surfacer, colour topcoat, and clearcoat.

Thus it has been observed that the adhesion defects increase in line with the harshness of the baking conditions, particularly when these conditions are close to, or even above, the upper limits of the operating window as recommended by the coating material manufacturers.

A lower level of reactivity on the part of the window adhesives, in contrast, has proved to be beneficial to the development of adhesion.

Whereas in the case of natural rubber and acrylic ester copolymers adhesion defects are a very frequent occurrence, adhesive masking tapes with self-adhesive compositions based on styrene block copolymers display particular compatibility with the adhesion of window adhesives. In application, however, there are other problems, originating from the thermal instability of this group of synthetic rubbers: above about 80° C., the styrene block copolymers begin to show weaknesses in cohesion, since above this temperature there is gradual softening of the styrene domains that are responsible for cohesion. At the point of application of the adhesive masking tape, the prevailing temperatures are up to 180° C.; in other words, the self-adhesive composition is completely liquefied and is no longer able sufficiently to withstand shearing forces, such as those which come about as a result of contraction of the backing when bonded through curves. As a result, the backing of the adhesive masking tape may be pulled out of its original position, the self-adhesive composition remaining there at least partially; in the course of demasking, after application, this results in residues of self-adhesive composition. If the window adhesive is applied to such residues, the failure of the bond is pre-programmed

DE 10 2004 063 330 A1 discloses an adhesive tape intended in particular for masking window flanges on automobiles, comprising a backing composed of two layers, one above the other, the first layer being composed of plasticized polyvinyl chloride (pPVC) and the second of unoriented polybutylene terephthalate (PBT), and also a self-adhesive composition applied to the first or the second layer.

The two layers arranged one atop another, of plasticized PVC and unoriented PBT, are joined to one another under the action of heat and pressure, without a laminating adhesive.

DE 199 52 211 A1 describes a laminate of plasticized PVC and polyester as backing material for an adhesive tape for masking window flanges.

DE 199 52 213 A1 discloses an adhesive tape intended in particular for window flange masking that comprises a backing material on one side of which is applied a self-adhesive composition based on a copolymer of ethylene, vinyl acetate, acrylic ester and, if desired, acrylamide. A copolymer of this kind is described in EP 0 017 986 A1.

In one preferred embodiment the self-adhesive composition is made up as follows:

| | |
|---|---|
| ethylene | 10% to 30%, more preferably 10% to 15% by weight |
| vinyl acetate | 20% to 55%, more preferably 30% to 35% by weight |
| acrylic ester | 30% to 69%, more preferably 50% to 60% by weight |
| acrylamide | 0% to 8%, more preferably 0.5% by weight |

It is an object of the invention to find a solution to masking with an adhesive tape that does not exhibit the above-outlined disadvantages of the prior art, or not to the same extent. The masking solution with an adhesive tape ought in particular not to produce any adhesion defects of the window adhesive on the areas previously masked, and ought not to exhibit any cohesion weaknesses, leading to residues of self-adhesive composition, at the temperatures used for application.

This object is achieved by means of the masking of window flanges with an adhesive tape comprising a self-adhesive composition based on crosslinked styrene block copolymers, as set out in the main claim. The dependent claims provide advantageous variant embodiments of this masking.

The invention accordingly provides the masking of substrates coated in particular with cathodic electrocoat (CED) material, more preferably of automotive window flanges, with an adhesive tape provided with a self-adhesive composition based on crosslinked styrene block copolymers, comprising masking with a single-layer or multi-layer backing and, applied to one side thereof, a self-adhesive composition comprising styrene block copolymers which are crosslinkable with metal chelates and which are blended at least with one or more tackifier resins. The styrene block copolymers are at least partly acid-modified or acid anhydride-modified, in order to be able to be complexed by the metal chelates. As a result of this crosslinking it is possible to achieve a large increase in temperature stability. Whereas for the normal, non-crosslinked styrene block copolymer compositions the test Shear Adhesion Failure Temperature (SAFT) is rarely above 120° C., chelate crosslinking allows it to be increased to more than 180° C.

The coatweight in the case of the masking tapes used for the masking solution is between 5 and 80 g/m², preferably between 12 and 40 g/M².

The bond strength to the CED substrates is between 1 and 8 N/cm, preferably between 2 and 4 N/cm.

Peel strength of CED after a thermal load in accordance with the application, of up to 100 minutes at 170° C., is in the range between 2 and 10 N/cm.

Self-adhesive compositions employed are preferably those based on block copolymers containing polymer blocks predominantly formed of vinylaromatics (A blocks), preferably styrene, and blocks predominantly formed by polymerization of 1,3-dienes (B blocks), preferably butadiene and isoprene. Both homopolymer and copolymer blocks can be utilized in accordance with the invention. Resulting block copolymers may contain identical or different B blocks, which may have been partly, selectively or fully hydrogenated. Block copolymers may have a linear A-B-A structure; likewise possible is the use of block copolymers of radial design, and also star-shaped and linear multiblock copolymers. Further components that may be present include A-B diblock copolymers. Block copolymers of vinylaromatics and isobutylene can likewise be employed in accordance with the invention. All of the aforementioned polymers may be utilized alone or in a mixture with one another.

At least some of the block copolymers used must be acid-modified or acid anhydride-modified, the modification taking place primarily by means of free-radical graft copolymerization of unsaturated monocarboxylic and polycarboxylic acids, such as fumaric acid, itaconic acid, citraconic acid, acrylic acid or polycarboxylic anhydrides, such as maleic anhydride, itaconic anhydride or citraconic anhydride, for example, preferably maleic anhydride. The fraction of acid or acid anhydride is preferably between 0.5 and 4 per cent by weight, based on the block copolymer as a whole.

The acid-modified or acid anhydride-modified polymers are preferably crosslinked using aluminium compounds or titanium compounds, especially aluminium or titanium chelates.

Block copolymers of this kind are available commercially under, for example, the name Kratonφ FG 1901 and Kraton® FG 1924 from Kraton, and as Tuftec® M 1913 and Tuftec® M 1943 from Asahi.

The pressure-sensitive adhesive preferably has a fraction of 20 to 70 per cent by weight of styrene block copolymer, preferably 30 to 60 per cent by weight, and with particular preference 35 to 55 per cent by weight, it not being necessary for the entire fraction of block copolymers to be in anhydride-modified form.

Besides the acid-modified or acid anhydride-modified vinylaromatic block copolymers already mentioned, it is also possible to add further acids or acid anhydrides in order to achieve a high degree of crosslinking and hence an even further increased cohesion. In this case it is possible to employ not only monomeric acid anhydrides and acids, as described in U.S. Pat. No. 3,970,608 A, but also acid-modified or acid anhydride-modified polymers and acid anhydride copolymers such as polyvinyl methyl ether-maleic anhydride copolymers, obtainable for example under the name Gantrez®, sold by ISP.

As tackifiers, self-adhesive compositions of the invention utilize as a main component, in particular, tackifier resins which are compatible with the elastomer block of the vinyl-aromatic block copolymers. Those suitable with preference include: unhydrogenated, partly hydrogenated or fully hydrogenated resins based on rosin and rosin derivatives, hydrogenated polymers of dicyclopentadiene, unhydrogenated, partly, selectively or fully hydrogenated hydrocarbon resins based on C₅, C₅/C₉ or C₉ monomer streams, polyterpene resins based on α-pinene and/or β-pinene and/or δ-limonene, and hydrogenated polymers of preferably pure C₈ and C₉ aromatics. Aforementioned tackified resins may be used either alone or in a mixture.

Further additives which can typically be utilized, for the purpose of achieving specific improvements or properties, include the following:
primary antioxidants, such as sterically hindered phenols
secondary antioxidants, such as phosphites or thioethers
in-process stabilizers, such as C radical scavengers
light stabilizers, such as UV absorbers or sterically hindered amines processing aids
endblock reinforcer resins
fillers, such as silicon dioxide, glass (ground or in the form of beads), aluminium oxides, zinc oxides, calcium carbonates, titanium dioxides, carbon blacks, etc., and also colour pigments and dyes
plasticizers, such as liquid resins, plasticizer oils or liquid polymers of low molecular mass, such as, for example, low molecular mass polybutenes having number-average molar masses<1500 g/mol
if desired, further polymers, preferably elastomeric in nature; elastomers which can be utilized accordingly include, among others, those based on single hydrocarbons, unsaturated polydienes for example, such as natural or synthetic polyisoprene or polybutadiene, chemically substantially saturated elastomers, such as saturated ethylene-propylene copolymers, α-olefin copolymers, polyisobutylene, butyl rubber, ethylene-propylene rubber, and chemically functionalized hydrocarbons, such as halogen-containing, acrylate-containing or vinyl ether-containing polyolefins, to name but a few.

The metals of the metal chelates may be those from main groups 2, 3, 4 and 5, and the transition metals. Particularly suitable examples include aluminium, tin, titanium, zirconium, hafnium, vanadium, niobium, chromium, manganese, iron, cobalt, and cerium.

Aluminium and titanium are particularly preferred.

The metal chelates may be represented by the following formula:

(R₁O)ₙM(XR₂Y)ₘ

where
M is a metal as described above;
R₁ is an alkyl or aryl group such as methyl, ethyl, butyl, isopropyl or benzyl;
n is zero or a greater whole number;
X and Y are oxygen or nitrogen, and may each also be attached through a double bond to R₂;
R₂ is an alkylene group connecting X and Y and may be branched, or else may contain oxygen or other heteroatoms in the chain;
X m is a whole number, but is at least 1.

Preferred chelate ligands are those which have come about from the reaction of the following compounds: triethanolamine, 2,4-pentanedione, 2-ethyl-1,3-hexanediol or lactic acid.

Particularly preferred crosslinkers are aluminium acetylacetonates and titanium acetylacetonates.

The aim here should be to choose an approximately equivalent ratio between the acid or acid anhydride groups and the acetylacetonate groups, in order to achieve optimum crosslinking; a small excess of crosslinker has been found to be positive.

The ratio between anhydride groups and acetylacetonate groups, however, can be varied; in this case the aim, for sufficient crosslinking, should be for neither of the two groups to be present in a molar excess of more than fivefold.

Suitable backings for the adhesive masking tape include in principle all flexible sheetlike materials having a thickness of between 30 and 300 μm, such as polymeric films, paper, metal foils or textiles (wovens, nonwovens). Owing to the required conformity when applying the adhesive masking tape, including when applying it around curves, and to the required toughness during demasking of the adhesive tape after use, polymeric films are of preferential suitability. Those deserving particular mention include polyester films (especially polyethylene terephthalate PET, glycol-modified polyethylene terephthalate PETG, or polyethylene naphthalate PEN, and also metalized, coextruded and/or primer-treated versions), polyimide films, PVC films, preferably plasticized PVC films, and polyolefin films (polyethylene and its copolymers, polypropylene and its copolymers, and blends of these).

Particular suitability is possessed by two-layer or multi-layer laminates of identical or different polymeric films or of polymeric films and paper and/or textiles (wovens, nonwovens). The laminates may be joined by self-adhesive compositions based for instance on natural rubber, synthetic rubber or acrylic ester polymers. Also suitable may be hotmelt adhesives such as ethylene copolymers (for example, ethylene-vinyl acetate, ethylene-acrylic acid or ethylene-maleic anhydride copolymers), or reactive laminating adhesives, based for example on polyurethane or epoxy. In certain cases, heat-induced laminations are also possible.

Prior to the coating or to the laminating of the adherends, the film surfaces can be optionally pretreated by corona discharge, flame treatment, plasma coating or wet-chemical priming, for the purpose of increasing adhesion.

During the laminating operation, the assembly of the adherends may be provided with a structure by means of an embossing die.

In principle there is no preferential side to which the self-adhesive composition is coated. Depending on the nature of the surface of the backing, suitable primers are advantageous for improving the anchorage of the self-adhesive composition.

In order to facilitate handling it is possible for the non-adhesive reverse face of the adhesive tape to have had applied to it an unwind-force-reducing lacquer, comprising a release agent such as silicone, organofluorine compounds or polyvinyl stearylcarbamate. Alternatively the adhesive tape may be applied on an easy-release liner material, such as a silicone-coated paper.

Rational application widths are 10 to 30 mm, depending on the size of the window to be installed. For curve bonding, the width of the adhesive tape ought not to exceed 15 mm, since otherwise crease-free application is virtually impossible. It should, however, also not be less than 10 mm, so that in each case there is a sufficiently large area for the reliable adhesion of window adhesive to exposed cathodic electrocoat. For application by robot, working widths of 12 to 15 mm are typical.

Further embraced by the concept of the invention is a window flange masked with a masking solution of the invention, and also a car with a window flange masked with a masking solution of the invention.

The masking solution of the invention is described below in a preferred embodiment with reference to examples, without wishing thereby to restrict the invention in any way whatsoever. Set out additionally are comparative examples, which present unsuitable masking solutions.

### EXAMPLES

Described below are the adhesive tapes with which masking was performed.

### Example 1

An adhesive composed of 50 parts of Kraton FG 1901 (SEBS, no diblock, with 30 per cent by weight (referred to below only as “%”) styrene content and, in grafted form, about 2% of maleic anhydride, product of the company Kraton), 50 parts of Kraton FG 1924 (SEBS with about 40% diblock, 13% block polystyrene and about 1% maleic anhydride, from Kraton), 90 parts of Regalite R 1100 (hydrogenated hydrocarbon resin with a softening point of about 110° C., from Eastman) and 20 parts of Regalite R 1010 (hydrogenated liquid hydrocarbon resin from Eastman) and 2 parts of aluminium acetylacetonate was dissolved in a mixture of toluene and isopropanol in a ratio of 9 to 1 and the solution was coated directly onto a 100 μm PET film, using a coating bar, in such a way that drying resulted in an adhesive coatweight of 25 g/m². Prior to its use, the specimen was lined with a siliconized release paper.

### Example 2

As Example 1, but using an adhesive with a composition of 50 parts Kraton FG 1901, 50 parts Kraton FG 1924, 120 parts Pentalyn H (hydrogenated rosin ester from Eastman), 15 parts Ondina G 41 (white oil with low naphthenic fraction, from Shell) and 2 parts titanyl acetylacetonate.

### Example 3

As Example 1, but using an adhesive with a composition of 50 parts Kraton FG 1901, 50 parts Kraton FG 1924, 70 parts Dercolyte A 115 (α-pinene resin with a softening point of about 115° C., from DRT), 40 parts Wingtack 10 (liquid hydrocarbon resin from Goodyear) and 2 parts acetylacetonate.

### Counterexample 1

As Example 1, but using an adhesive composed of 50 parts Kraton G 1650 (SEBS, no diblock, with 30% styrene content, no maleic anhydride, product of the company Kraton), 50 parts Kraton G 1657 (SEBS with about 40% diblock, 13% block polystyrene, no maleic anhydride, from Kraton), 90 parts Regalite R 1100 and 20 parts Regalite R 1010.

### Counterexample 2

As Example 1, but using an adhesive with a composition of 50 parts Kraton G 1650, 50 parts Kraton G 1657, 120 parts Pentalyn H and 15 parts Ondina G 41.

### Counterexample 3

As Example 1, but carrying out priming with a solution of 2 parts of natural rubber in toluene, which had been mixed with 1 part of diphenylmethane diisocyanate, with a coatweight of 0.3 g/m². In a downstream operation this primer was coated with a natural rubber self-adhesive composition. The self-adhesive composition consisted of 100 parts natural rubber, 10 parts zinc oxide, 20 parts Pentalyn H, 10 parts Vulkaresen PA 510 (reactive alkylphenol resin from Schenectady), 50 parts Regalite R 1100 and 5 parts Ondina G 41.

### Counterexample 4

As Example 1, but carrying out priming with a solution of polyvinylidene chloride in toluene. In a downstream operation an acrylic ester copolymer as self-adhesive composition was coated onto this primer. The self-adhesive composition consisted of 40 parts butyl acrylate, 40 parts 2-ethylhexyl acrylate, 12 parts vinyl acetate, 5 parts methyl acrylate and 3 parts acrylic acid.

### Test Criteria

Decisive test criteria considered important, and thus employed, for the present addressed problem were as follows:
adhesive residues on the cathodic electrocoat after thermal loading in bonds with a defined radius
adhesion defect of window adhesive on the sites formerly bonded with adhesive masking tapes described in the examples

### Test Implementation

Adhesive Residues

Strips 15 mm wide were cut as test strips from the coated specimens. These test strips were adhered, as far as possible without creases, and with a radius of 200 mm, to a metal panel coated with cathodic electrocoat (Cathoguard 500 from BASF) and baked according to manufacturer instructions, this adhering was possible only with slight stretching of the backing.

Subsequently the panel thus bonded was placed in a heating cabinet which had been preheated to 170° C., and left there for an hour. After the panel had cooled, the external radius of the test strip was assessed for adhesive residues.

The evaluation criteria were as follows:
+ for no or minimal adhesive residues
− for distinctly visible adhesive residues

### Adhesion Defects

Strips 15 mm wide were cut as test strips from the coated specimens. These test strips were adhered in a straight line without creases to a metal panel coated with cathodic electrocoat (Cathoguard 500) and baked according to manufacturer instructions.

The panel thus bonded was subsequently placed in a heating cabinet, which had been preheated to 170° C., and left there for an hour and forty minutes. After the panel had cooled, the test strip was removed, and a reactive one-component PU window adhesive (Sikaflex DM2 from Sika), which for the purpose of improved processing had been preheated to 50° C., was applied, in the form of a triangular bead with a width of about 1 cm and a height of 1 cm, to the site of former bonding. The triangular profile, whose base lay on the cathodic electrocoat, was pressed flat, using a polyethylene plate, so that the bead subsequently had a height of about 0.5 cm and a width of about 1.2 cm.

The metal panel was stored for ten days at 23° C.±1° C. and at a relative humidity of 50%±1% for the adhesive to cure.

After curing had taken place, the bead of adhesive was raised at one prepared end and peeled from the metal panel at an angle of approximately 90°.

If bonding has been effective, exclusively cohesion failure occurs within the adhesive bead—that is, no adhesion failure to the cathodic electrocoat. Continued peeling of the bead is then achieved by making incisions with a knife into the cohesively fracturing bead residue down to the electrocoat.

In the case of adhesion failure, the bead of adhesive can be peeled from the electrocoat without substantial residues. If the proportion of adhesion fraction is more than 10%, the test is classed as failed.

The evaluation criteria used were as follows:
+ for less than 10% adhesion fracture
− for more than 10% adhesion fracture

### Results

The results of the masking solutions are summarized in the following table.

| | Adhesive residues | Adhesion defects |
|---|---|---|
| Example 1 | + | + |
| Example 2 | + | + |
| Example 3 | + | + |
| Counterexample 1 | − | + |
| Counterexample 2 | − | + |
| Counterexample 3 | + | − |
| Counterexample 4 | + | − |

It is apparent that the masking solutions of the invention meet both important criteria simultaneously, whereas the prior-art counterexamples each meet only one, and are therefore unsuitable.

1. A method of masking a substrate, said method comprising applying an adhesive tape to said substrate, said adhesive tape comprising a single-layer or multi-layer backing and a self-adhesive composition applied to one side thereof, said self-adhesive composition comprising metal chelate-crosslinkable vinylaromatic block copolymers, which are blended at least with one or more tackifier resins, the vinylaromatic block copolymers being at least partly acid-modified or acid anhydride-modified.

2. The method according to claim 1, wherein the the vinylaromatic block copolymers are partly acid-modified or acid anhydride-modified to an extent between 0.5 and 4 per cent by weight, based on each block copolymer as a whole.

3. The method according to claim 1, wherein the self-adhesive composition comprise a fraction of 20 to 70 per cent by weigh of vinylaromatic block copolymer.

4. The method according to the vinylaromatic block copolymers are formed of vinylaromatics (A blocks), and blocks formed by polymerization of 1,3-dienes (B blocks).

5. The method according to at claim 1, wherein the self-adhesive composition is composed of at least one acid-modified or acid anhydride-modified vinylaromatic block copolymer,
at least one metal chelate of the following formula:
(R₁O)ₙM(XR₂Y)ₘ
where
M is a metal of main group 2, 3, 4 or 5 or a transition metal;
R₁ is an alkyl or aryl group;
n is zero or a greater whole number;
X and Y are oxygen or nitrogen, and may each also be attached through a double bond to R₂;
R₂ is an alkylene group connecting X and Y and may be branched, or else may contain oxygen or other heteroatoms in the chain;
m is a whole number, but is at least 1,
and also at least one tackifier resin.

6. The method according to claim 1, wherein the self-adhesive composition is crosslinked with the aid of chelate ligands, and the chelate ligands used are those formed from the reaction of the following compounds: triethanolamine, 2,4-pentanedione, 2-ethyl-1,3-hexanediol or lactic acid.

7. The method according to claim 1, wherein the self-adhesive composition is crosslinked with the aid of crosslinkers, and the crosslinkers used are aluminium acetylacetonates c titanium acetylacetonates.

8. The method according to claim 1, wherein self-adhesive composition further comprises one or more of blend components, plasticizers, ageing inhibitors, processing aids, fillers, dyes and; stabilizers.

9. The method according to claim 1, wherein self-adhesive composition is applied to the backing in a coatweight between 5 and 80 g/m².

10. The method according to claim 1, wherein adhesive tape exhibits a bond strength on the CED substrates of between 1 and 8 N/cm, and/or a peel strength from a cathodic electrocoat after thermal exposure of up to 100 minutes at 170° C. in the range between 2 and 10 N/cm.

11. Window flange masked with an adhesive tape according to the method of claim 1.

12. Car with a window flange according claim 11.
